(19) United States
(12) Patent Application Publication
(10) Pub. No.: US 2013/0061460 A1
(43) Pub. Date: Mar. 14, 2013

(54) METHOD OF MANUFACTURING NONAQUEOUS ELECTROLYTE SECONDARY BATTERY

(71) Applicant: Yusuke ONODA, Toyota-shi (JP)

(72) Inventor: Yusuke ONODA, Toyota-shi (JP)

(21) Appl. No.: 13/609,408

(22) Filed: Sep. 11, 2012

(30) Foreign Application Priority Data
Sep. 12, 2011 (JP) 2011-198113

(51) Int. Cl. H01M 10/04

(52) U.S. Cl. 29/623.5; 29/623.1; 29/623.2; 141/5

(57) ABSTRACT

A nonaqueous electrolyte solution is prepared in a divided form as a first solution having a lower solute content rate than the nonaqueous electrolyte solution, and a second solution formed of ingredients of the nonaqueous electrolyte solution excluding ingredients of the first solution. Next, the first solution is injected into a battery case housing an electrode assembly. Then, the first solution is impregnated into the electrode assembly. Subsequently, the second solution is injected into the battery case. Then, the second solution is impregnated into the electrode assembly.

### INCORPORATION BY REFERENCE

The disclosure of Japanese Patent Application No. 2011-198113 filed on Sep. 12, 2011 including the specification, drawings and abstract is incorporated herein by reference in its entirety.

### BACKGROUND OF THE INVENTION

1. Field of the Invention

The invention relates to a method of manufacturing a nonaqueous electrolyte secondary battery.

2. Description of Related Art

Nonaqueous electrolyte secondary batteries such as lithium ion secondary batteries attract attention today as power supplies for mobile devices, and also as power supplies for electric vehicles and hybrid automobiles. A variety of methods for manufacturing nonaqueous electrolyte secondary batteries have hitherto been disclosed (see, for example, Japanese Patent Application Publication No. 10-50339 (JP-10-50339 A).

JP-10-50339 A describes a method of manufacturing the following type of lithium ion secondary battery. A nonaqueous electrolyte solution is injected into a cylindrical lithium ion secondary battery, and impregnated therein under reduced pressure. In the working examples of JP-10-50339 A, such injection of the solution is carried out a plurality of times. Also, when the pressure is lowered, pressure reduction and pressure increase are intermittently and repeatedly carried out. The disclosure mentions that the impregnating ability of the electrolyte solution is thereby enhanced.

JP-10-50339 A also mentions that the impregnating ability of a nonaqueous electrolyte solution can be enhanced by introducing the electrolyte solution as a plurality of divided portions. Specifically, in JP-10-50339 A, the overall amount of the nonaqueous electrolyte solution is simply divided up (i.e., the nonaqueous electrolyte solution is divided into a plurality of portions having equal ingredient content rate), and the portions of nonaqueous electrolyte solution are injected into the battery.

However, in recent years, there has existed a desire to further shorten the production time of nonaqueous electrolyte secondary batteries. To this end, a technique for impregnating a nonaqueous electrolyte solution into the electrode assembly within a short period of time has been sought.

### SUMMARY OF THE INVENTION

The invention provides a method of manufacturing a nonaqueous electrolyte secondary battery wherein that the nonaqueous electrolyte solution can be impregnated into the electrode assembly in a short period of time.

According to one aspect, the invention relates to a method of manufacturing a nonaqueous electrolyte secondary battery including an electrode assembly that includes a positive electrode, a negative electrode and a separator, a battery case that houses the electrode assembly, and a nonaqueous electrolyte solution impregnated into the electrode assembly. This manufacturing method includes a first injection step in which the nonaqueous electrolyte solution is prepared in a divided form as a first solution having a lower solute content rate than the nonaqueous electrolyte solution and a second solution formed of ingredients of the nonaqueous electrolyte solution excluding ingredients of the first solution, and the first solution is injected into the battery case housing the electrode assembly; a first impregnation step in which the first solution is impregnated into the electrode assembly; a second injection step in which the second solution is injected into the battery case; and a second impregnation step in which the second solution is impregnated into the electrode assembly.

For example, when injection of the nonaqueous electrolyte solution into the battery case is divided into two steps, that is, a first injection step and a second injection step, instead of simply dividing up the overall amount of the nonaqueous electrolyte solution (i.e., dividing the nonaqueous electrolyte solution into two portions having equal ingredient content rate), the nonaqueous electrolyte solution is prepared in a divided form as: a first solution having a lower solute content rate than the nonaqueous electrolyte solution, and a second solution formed of ingredients remaining after ingredients of the first solution are removed from the nonaqueous electrolyte solution. It is also possible to carry out the injection step and the impregnation each three or more times.

Next, in the first injection step, the first solution is injected into the battery case housing the electrode assembly. Then, in the first impregnation step, the first solution is impregnated into the electrode assembly. The first solution having a lower solute content rate than the nonaqueous electrolyte solution has a faster rate of impregnation into the electrode assembly than the nonaqueous electrolyte solution. That is, the rate of impregnation by the first solution into the electrode assembly is more rapid than the rate of impregnation by the nonaqueous electrolyte solution. This is because solute present within a solution lowers the rate of impregnation by the solution into the electrode assembly, and the first solution has a lower solute content rate than the nonaqueous electrolyte solution.

Next, in the second injection step, the second solution is injected into the battery case, following which, in the second impregnation step, the second solution is impregnated into the electrode assembly. Because the electrode assembly has already been wetted by the first solution (solvent), even the second solution having a high solute content rate can be impregnated rapidly (in a short time) into the electrode assembly.

It is thus possible, using the above-described manufacturing method, to impregnate a nonaqueous electrolyte solution into an electrode assembly within a short period of time.

Here, “first solution having a lower solute content rate than the nonaqueous electrolyte solution” encompasses also a first solution having a solute content rate of 0 wt %. That is, this phrase encompasses a first solution formed solely of part of a solvent included in the nonaqueous electrolyte solution. If the first solution does not impregnate completely into the electrode assembly during the first impregnation step, with some of the first solution remaining outside of the electrode assembly, this remaining portion of the first solution is subsequently impregnated into the electrode assembly together with the second solution in the second impregnation step.

The above method of manufacture may alternatively be referred to as a nonaqueous electrolyte secondary battery manufacturing method which includes the step of injecting a first nonaqueous electrolyte solution into a battery case housing an electrode assembly and the step of impregnating the first nonaqueous electrolyte solution into the electrode assembly, followed by the step of injecting into the battery case a second nonaqueous electrolyte solution having a higher solute concentration than the first nonaqueous electrolyte solution and the step of impregnating the second nonaqueous electrolyte solution into the electrode assembly.

What this means is that, in cases where a nonaqueous electrolyte solution is introduced into a battery case in two divided portions, for example, letting the solute and solvent in the first nonaqueous electrolyte solution be respectively A (g) and B (g), and letting the solute and solvent in the second nonaqueous electrolyte solution be respectively C (g) and D (g), the concentration (A+C)/(B+D) % coincides with the final concentration of the nonaqueous electrolyte solution.

In the above method of manufacturing a nonaqueous electrolyte secondary battery, the first solution may be consisting of part of a solvent included in the nonaqueous electrolyte.

In the above-described manufacturing method, part of the solvent included in the nonaqueous electrolyte solution may be used as the first solution. That is, in the first injection step, part of the solvent included in the nonaqueous electrolyte solution is injected into the battery case, after which, in the first impregnation step, this solvent is impregnated into the electrode assembly. The rate of impregnation by the solvent into the electrode assembly is very rapid compared to the rate of impregnation by the nonaqueous electrolyte solution. The rate of impregnation by the second solution in the second impregnation step may also be made rapid. It is thus possible, using the above-described manufacturing method, to impregnate a nonaqueous electrolyte solution into an electrode assembly in a shorter period of time.

In cases where the solvent included in the nonaqueous electrolyte solution is formed of a plurality of different ingredients (e.g., dimethyl carbonate (DMC) and ethyl methyl carbonate (EMC)), “part of the solvent included in the nonaqueous electrolyte solution” is exemplified by one solvent ingredient from among the solvents (e.g., DMC alone). Alternatively, a plurality of different ingredients (e.g., DMC and EMC) may be included, in which case the liquid amounts thereof may be set to parts of the total amounts of the solvents included in the nonaqueous electrolyte solution (e.g., part of DMC and part of EMC).

“Part of the solvent included in the nonaqueous electrolyte solution” also encompasses solutions containing a trace amount of solute ingredients. That is, the above-described first solution refers to a solution which is substantially formed of a part of the solvent included in the nonaqueous electrolyte solution, and does not exclude solutions containing trace amounts (amounts which do not affect the rate of impregnation into the electrode assembly) of solute ingredients.

Moreover, in the first impregnation step and the second impregnation step, an operation of reducing pressure within the battery case then increasing the pressure may be carried out a plurality of times.

According to this operations, the rates of impregnation of the first solution and the second solution into the electrode assembly can thereby be increased even further.

The operation of reducing the pressure within the battery case then increasing the pressure is exemplified by reducing the pressure within the battery case from an atmospheric pressure state, then raising the pressure to atmospheric pressure (opening to the atmosphere). In the first impregnation step and the second impregnation step, the operation of reducing pressure within the battery case then increasing the pressure is carried out a plurality of times, following which the pressure within the battery case may be placed in a constant pressure state (e.g., atmospheric pressure state) and left to stand for a given period of time.

### BRIEF DESCRIPTION OF THE DRAWINGS

Features, advantages, and the technical and industrial significance of exemplary embodiments of the invention will be described below with reference to the accompanying drawings, in which like numerals denote like elements, and wherein:

FIG. 1 is a cross-sectional view of a nonaqueous electrolyte secondary battery;

FIG. 2 is a perspective view of an electrode assembly in the nonaqueous electrolyte secondary battery;

FIG. 3 is a diagram showing a positive electrode in the electrode assembly;

FIG. 4 is a diagram showing a negative electrode in the electrode assembly;

FIG. 5 is a diagram showing the manner in which the electrode assembly is formed;

FIG. 6 is a flow chart showing the sequence of steps in the method of manufacturing a nonaqueous electrolyte secondary battery according to an embodiment of the invention;

FIG. 7 is a diagram illustrating the method of manufacturing a nonaqueous electrolyte secondary battery according to an embodiment of the invention;

FIG. 8 is a graph comparing the impregnation completion times of nonaqueous electrolyte solutions; and

FIG. 9 is a graph showing the LiPF₆ concentration distributions within the electrode assemblies.

### DETAILED DESCRIPTION OF EMBODIMENTS

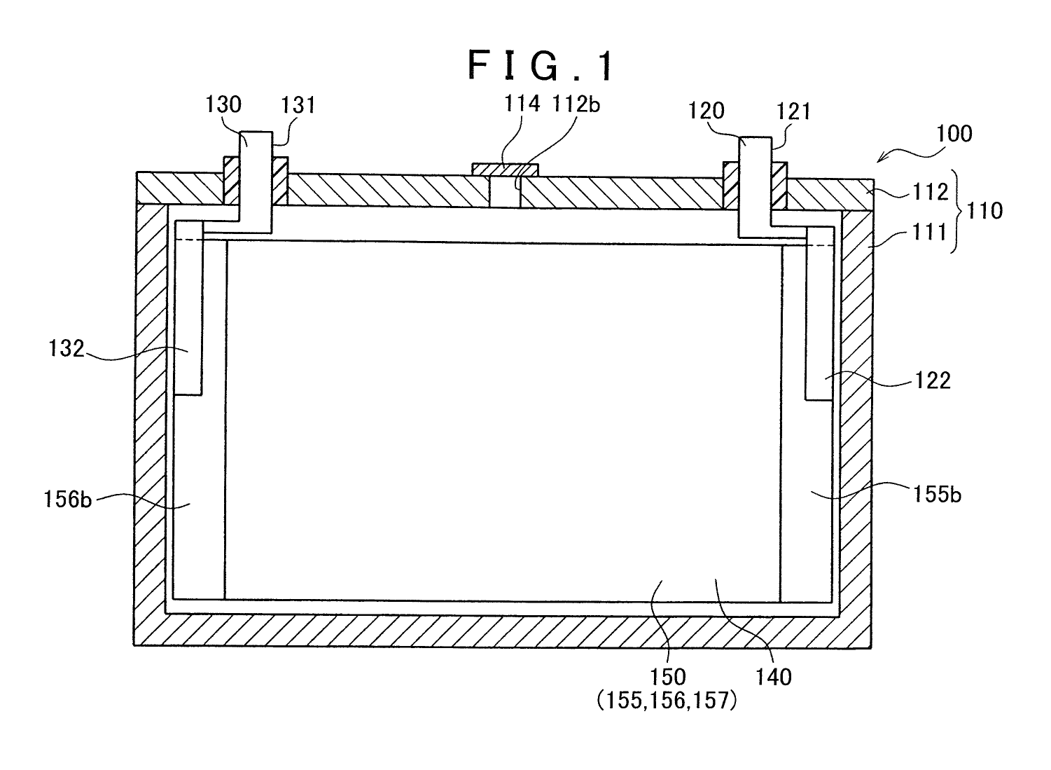

First, a nonaqueous electrolyte secondary battery 100 produced by the method of manufacture of the present embodiment is described. Referring to FIG. 1, the nonaqueous electrolyte secondary battery 100 is a prismatic sealed lithium ion secondary battery having a battery case 110 of rectangular shape, an external positive electrode terminal 121 and an external negative electrode terminal 131. The battery case 110 is a hard case having a prismatic metal receptacle 111 and a metal lid 112 which together form a rectangular enclosed space. The electrode assembly 150 and the like are housed in the interior of the battery case 110 (prismatic receptacle 111).

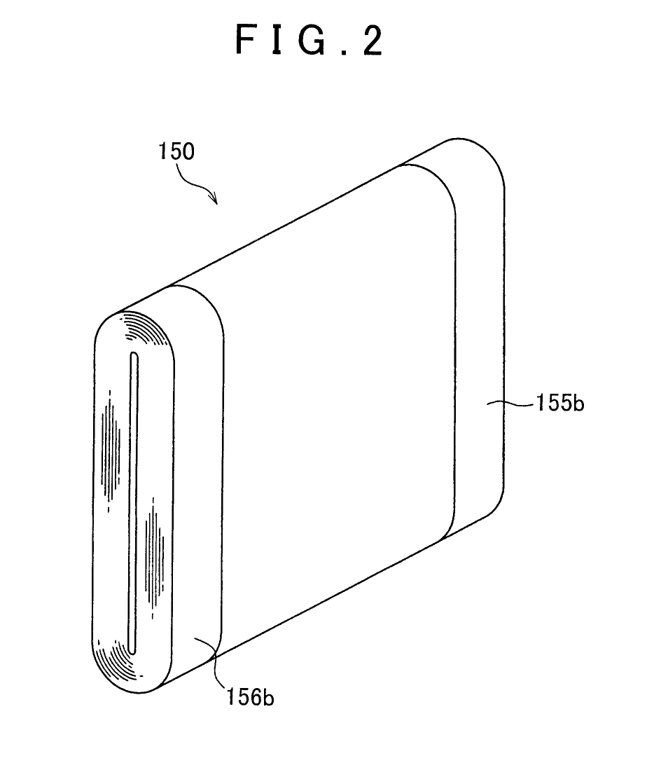

The electrode assembly 150 is a flat coiled electrode assembly formed of a sheet-shape positive electrode 155, a sheet-shape negative electrode 156 and a sheet-shape separator 157 which have been rolled up together into a flattened shape (see FIG. 2).

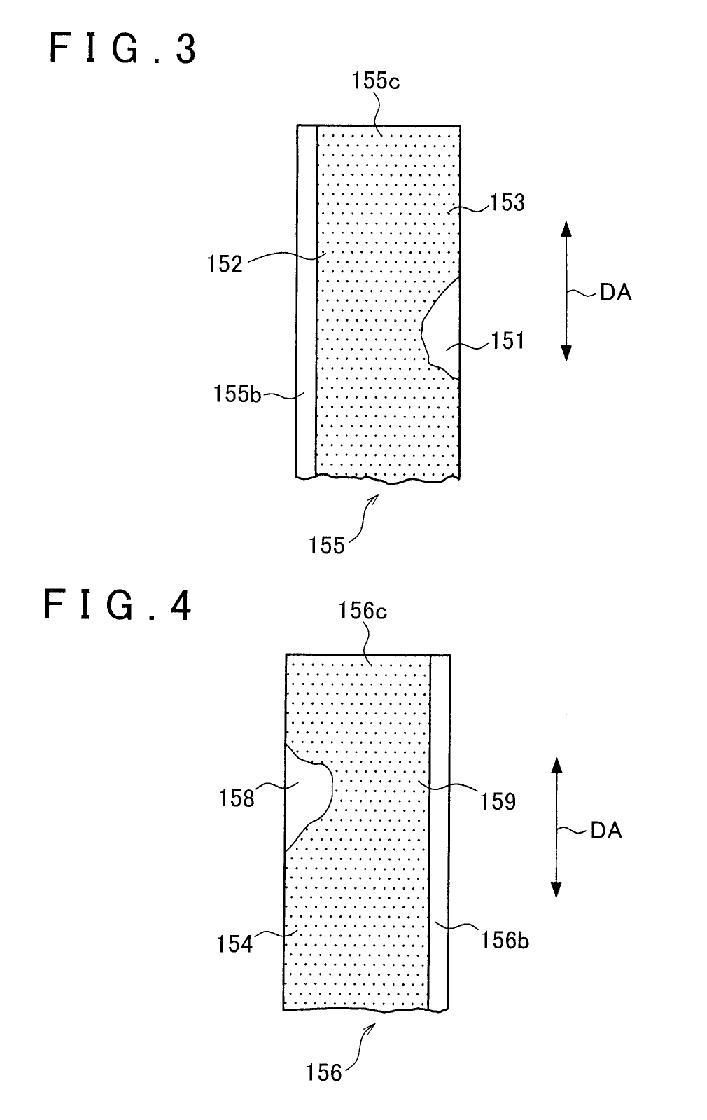

As shown in FIG. 3, the positive electrode 155 has a positive electrode current collecting member 151 which is made of aluminum foil and is in the form of a strip that extends in the lengthwise direction DA, and has two positive electrode composite material layers 152 disposed as strips, each extending in the lengthwise direction DA, on both faces of the positive electrode current collecting member 151. The positive electrode composite material layers 152 contain a positive electrode active material 153, a conductive material made of acetylene black, and polyvinylidene fluoride (PVdF, a binder) in proportions of 89:8:3 (weight ratio).

Areas of the positive electrode 155 which are coated with the positive electrode composite material layers 152 are referred to as the positive electrode composite material layer coated region 155c, and areas which do not have the positive electrode composite material layers 152 thereon and are composed only of the positive electrode current collecting member 151 are referred as the positive electrode composite material layer uncoated region 155b. The positive electrode composite material layer uncoated region 155b extends in the form of a strip in the lengthwise direction DA of the positive electrode 155 along one long edge thereof. This positive electrode composite material layer uncoated region 155b is coiled into a spiral shape and positioned at one end (the right end in FIGS. 1 and 2) in the axial direction (left-right direction in FIG. 1) of the electrode assembly 150. In this embodiment, LiNi_{1/3}Co_{1/3}Mn_{1/3}O₂ is used as the positive electrode active material 153.

As shown in FIG. 4, the negative electrode 156 has a negative electrode current collecting member 158 which is made of copper foil and is in the form of a strip that extends in the lengthwise direction DA, and has two negative electrode composite material layers 159 disposed as strips, each extending in the lengthwise direction DA, on both faces of the negative electrode current collecting member 158. The negative electrode composite material layers 159 contain a negative electrode active material 154, styrene-butadiene rubber (SBR, a binder), and carboxymethyl cellulose (CMC, a thickener) in proportions of 98:1:1 (weight ratio).

Areas of the negative electrode 156 which are coated with the negative electrode composite material layers 159 are referred to as the negative electrode composite material layer coated region 156c, and areas which do not have negative electrode composite material layers 159 and are composed only of the negative electrode current collecting member 158 are referred to as the negative electrode composite material layer uncoated region 156b. The negative electrode composite material layer uncoated region 156b extends in the form of a strip in the lengthwise direction DA of the negative electrode 156 along one long edge thereof. This negative electrode composite material layer uncoated region 156b is coiled into a spiral shape and positioned at one end (the left end in FIGS. 1 and 2) in the axial direction of the electrode assembly 150. In this embodiment, graphite is used as the negative electrode active material 154.

The positive electrode composite material layer uncoated region 155b is electrically connected, through a positive electrode connector 122, to the external positive electrode terminal 121 (see FIG. 1). Likewise, the negative electrode composite material layer uncoated region 156b is electrically connected, through a negative electrode connector 132, to the external negative electrode terminal 131. Moreover, the external positive electrode terminal 121 and the positive electrode connector 122 are integrally formed so as to make up a positive electrode current collecting terminal member 120. Similarly, the external negative electrode terminal 131 and the negative electrode connector 132 are integrally formed so as to make up a negative electrode current collecting terminal member 130.

The separator 157 is formed of three layers: polypropylene (PP)/polyethylene (PE)/polypropylene (PP). This separator 157 is interposed between, and spaces apart, the positive electrode 155 and the negative electrode 156. The separator 157 is impregnated with a lithium ion-containing nonaqueous electrolyte solution 140.

In this embodiment, a nonaqueous solution of lithium hexafluorophosphate (LiPF₆), which is a lithium salt, and ethylene carbonate (EC) dissolved in a nonaqueous solvent formed of, in admixture, DMC, EMC and additive is used as the nonaqueous electrolyte solution 140. More specifically, the nonaqueous electrolyte solution 140 contains 40.1 g of DMC, 28.6 g of EMC, 2.5 g of additive, 16.0 g of LiPF₆, and 37.8 g of EC. The solute content rate in this nonaqueous electrolyte solution 140 is 43.0 wt %, and the molar concentration of LiPF₆ in the nonaqueous electrolyte solution 140 is 1.1 mol/L.

Next, the method of manufacturing a nonaqueous electrolyte secondary battery according to this embodiment is described. First, in step S1, the battery is assembled. That is, as shown in FIG. 3, a positive electrode 155 formed of a positive electrode composite material layer 152 coated onto the surfaces (both sides) of a positive electrode current conducting member 151 in the form of a strip is prepared. In addition, as shown in FIG. 4, a negative electrode 156 formed of a negative electrode composite material layer 159 coated onto the surfaces (both sides) of a negative electrode current conducting member 158 in the form of a strip is prepared.

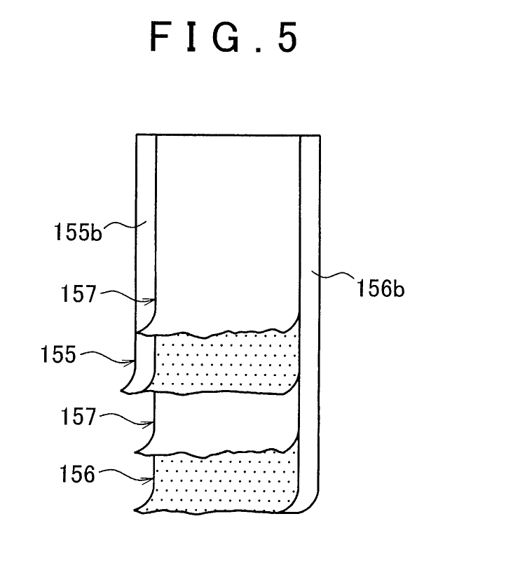

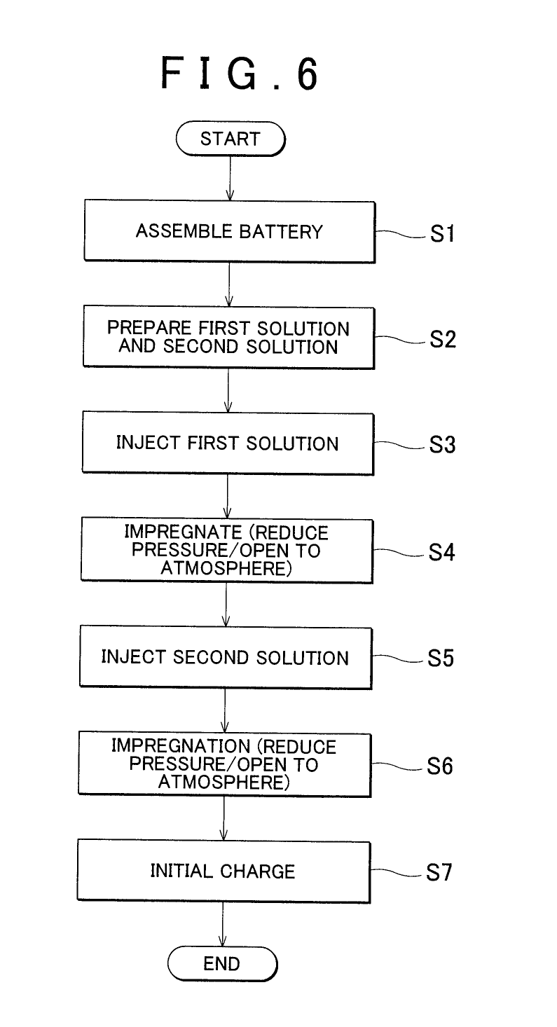

Next, as shown in FIG. 5, the negative electrode 156, a separator 157, the positive electrode 155 and a separator 157 are overlapped in this order and coiled together. More specifically, with the positive electrode composite material layer uncoated region 155b of the positive electrode 155 and the negative electrode composite material layer uncoated region 156b of the negative electrode 156 situated on mutually opposing sides in the width direction (the left-right direction in FIG. 5), the negative electrode 156, a separator 157, the positive electrode 155 and a separator 157 are coiled together in a flattened shape, thereby forming the electrode assembly 150 (see FIG. 2).

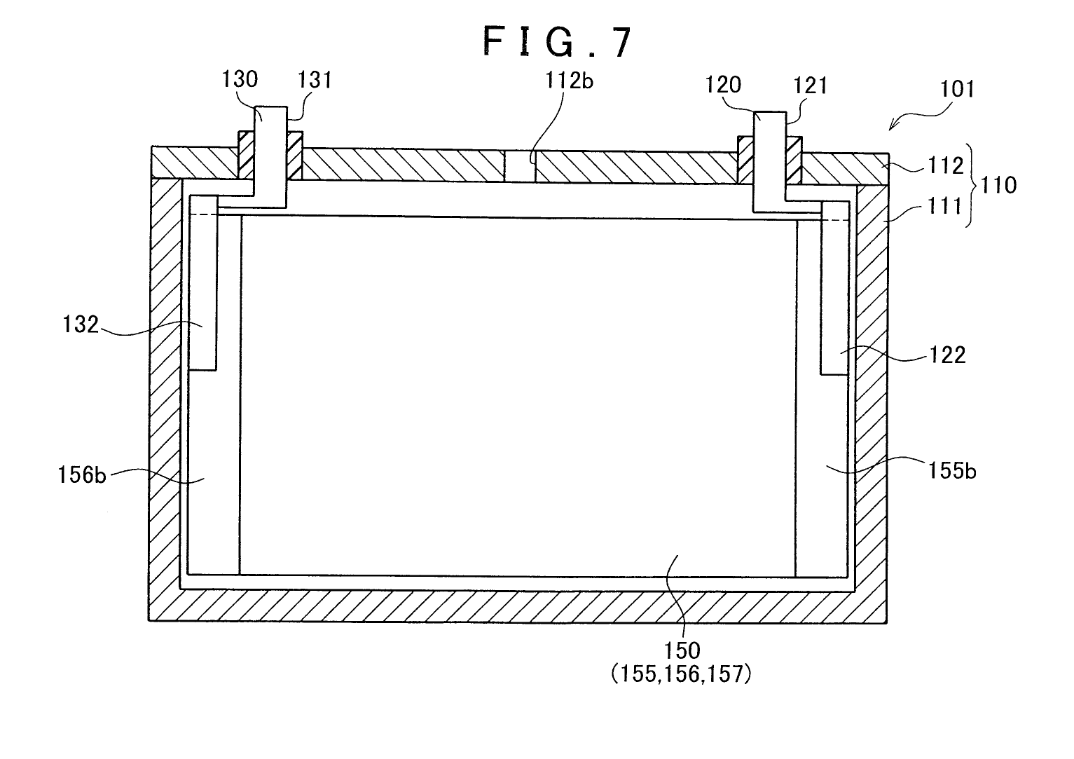

Next, the positive electrode composite material layer uncoated region 155b of the electrode assembly 150 and the positive electrode connector 122 of the positive electrode current collecting terminal member 120 are welded together. Similarly, the negative electrode composite material layer uncoated region 156b of the electrode assembly 150 and the negative electrode connector 132 of the negative electrode current collecting terminal member 130 are welded together. Next, the electrode assembly 150 in which the positive electrode current collecting terminal member 120 and the negative electrode current collecting terminal member 130 have been welded is placed within the prismatic receptacle 111 and the opening in the prismatic receptacle 111 is closed with the lid 112. The lid 112 and the prismatic receptacle 111 are then welded together, thereby completing the assembled body 101 formed of the electrode assembly 150 housed within the battery case 110 (see FIG. 7). In addition, a solution injection port 112b which passes through the lid 112 is formed at the center of the lid 112.

Next, proceeding to step S2, a first solution and a second solution are prepared. That is, a nonaqueous electrolyte solution 140 is prepared in a divided form as a first solution having a lower solute content rate than the nonaqueous electrolyte solution 140 and a second solution formed of ingredients of the nonaqueous electrolyte solution 140 excluding ingredients of the first solution.

Next, proceeding to step S3 (first injection step), the first solution is injected into the battery case 110 through the injection port 112b in the battery case 110.

Proceeding next to step S4 (first impregnation step), the first solution is impregnated into the electrode assembly 150. That is, the operation of reducing the pressure within the battery case 110 then increasing the pressure is carried out a plurality of times (in this embodiment, five times). Specifically, using a vacuum pump (not shown), gases within the battery case 110 are discharged to the exterior through the injection port 112b in the battery case 110, thereby reducing the pressure within the battery case 110 (in this embodiment, the pressure is reduced from atmospheric pressure to 100 kPa). Next, the pressure within the battery case 110 is increased to atmospheric pressure (opened to the atmosphere). This operation is carried out a plurality of times (in this embodiment, five times), thereby enabling the rate of impregnation of the first solution into the electrode assembly 150 to be increased. The pressure within the battery case 110 is subsequently held in an atmospheric pressure state for a given length of time (in this embodiment, 20 minutes).

Next, proceeding to step S5 (second injection step), the second solution is injected into the battery case 110 through the injection port 112b in the battery case 110.

Proceeding next to step S6 (second impregnation step), the second solution is impregnated into the electrode assembly 150. That is, as in step S4, the operation of reducing the pressure within the battery case 110 then increasing the pressure is carried out a plurality of times (in this embodiment, five times). Specifically, using a vacuum pump (not shown), gases within the battery case 110 are discharged to the exterior through the injection port 112b in the battery case 110, thereby reducing the pressure within the battery case 110 (in this embodiment, the pressure is reduced from atmospheric pressure to 100 kPa). Next, the pressure within the battery case 110 is increased to atmospheric pressure (opened to the atmosphere). This operation is carried out a plurality of times (in this embodiment, five times), thereby enabling the rate of impregnation of the second solution into the electrode assembly 150 to be increased. With subsequently holding the pressure within the battery case 110 in an atmospheric pressure state, impregnation of the first solution and the second solution is completed (nonaqueous electrolyte solution 140). With impregnation of the first solution and the second solution into the electrode assembly 150, the interior of the electrode assembly 150 is impregnated with the nonaqueous electrolyte solution 140.

If, in step S4 (first impregnation step), the first solution does not completely impregnate into the electrode assembly 150 and some of the first solution remains outside of the electrode assembly 150, this remaining part of the first solution will then impregnate into the electrode assembly 150 together with the second solution in step S6 (second impregnation step), thus enabling, as noted above, the nonaqueous electrolyte solution 140 to be impregnated into the electrode assembly 150.

Next, the injection port 112b is sealed with an injection cap 114, after which, proceeding to step S7, initial charging of the nonaqueous electrolyte secondary battery is carried out. For example, charging is begun at a constant current of 1 C up to a battery voltage of 4.1 V, then continued while holding the battery voltage at 4.1 V, and completed when the charging current value falls to 0.1 A. The nonaqueous electrolyte secondary battery is thereby set to a state of charge (SOC) of 100%. This operation completes production of the nonaqueous electrolyte secondary battery 100.

1 C is the current value at which a battery having a capacity which is the rated capacity value (nominal capacity value), when constant-current discharged, reaches end of discharge in 1 hour. For example, when the rated capacity (nominal capacity) of a nonaqueous electrolyte secondary battery is 5.0 Ah, 1 C=5.0 A.

### Example 1

In Example 1, a solvent obtained by mixing together 24 g of DMC and 16 g of EMC was used as the first solution (see Table 1). The solute content rate of the first solution was thus (0/40)×100=0 (wt %).

A solution formed of the ingredients of the nonaqueous electrolyte solution excluding ingredients of the above first solution (24 g of DMC and 16 g of EMC) from the nonaqueous electrolyte solution 140 was used as the second solution. Specifically, a solution prepared by dissolving 16 g of LiPF₆ and 37.8 g of EC in a solvent obtained by mixing together 16.1 g of DMC, 12.6 g of EMC and 2.5 g of additive was used as the second solution (see Table 1). The solute content rate of the second solution was thus [(16.0+37.8)/85]×100=63.3 (wt %).

TABLE 1

| | | | Example 2 | | Example 1 | |
|---|---|---|---|---|---|---|
| | | Comparative | First | Second | First | Second |
| | | example | solution | solution | solution | solution |
| Solute | LiPF₆ | 16.0 | 2.9 | 13.1 | — | 16.0 |
| (g) | EC | 37.8 | 12.9 | 24.9 | — | 37.8 |
| Solvent | DMC | 40.1 | 13.6 | 26.5 | 24.0 | 16.1 |
| (g) | EMC | 28.6 | 9.7 | 18.9 | 16.0 | 12.6 |
| | Additive | 2.5 | 0.9 | 1.6 | — | 2.5 |

| | | | | | |
|---|---|---|---|---|---|
| Amount of solution | 125 | 40 | 85 | 40 | 85 |
| (g) | | | | | |
| Solute content rate | 43.0 | 39.5 | 44.7 | 0 | 63.3 |
| (wt %) | | | | | |

As indicated above, in Example 1, the solute content rate of the first solution is set to 0 wt %. Hence, in Example 1, the solute content rate of the first solution is lower than the solute content rate of the nonaqueous electrolyte solution 140 (43.0 wt %). Also, in Example 1, the solute content rate of the second solution is set to 63.3 wt %. Hence, the solute content rate of the second solution is higher than the solute content rate of the nonaqueous electrolyte solution 140 (43.0 wt %). Mixing together the first solution and the second solution of Example 1 gives 125 g of the nonaqueous electrolyte solution 140.

### Example 2

In Example 2, a solution prepared by dissolving 2.9 g of LiPF₆ and 12.9 g of EC in a solvent obtained by mixing together 13.6 g of DMC, 9.7 g of EMC and 0.9 g of additive was used as the first solution (see Table 1). The solute content rate of the first solution was thus [(2.9+12.9)/40]×100=39.5 (wt %).

A solution prepared by dissolving 13.1 g of LiPF₆ and 24.9 g of EC in a solvent obtained by mixing together 26.5 g of DMC, 18.9 g of EMC and 1.6 g of additive was used as the second solution (see Table 1). The solute content rate of the second solution was thus [(13.1+24.9)/85]×100=44.7 (wt %).

As indicated above, in Example 2, the solute content rate of the first solution is set to 39.5 wt %. Hence, in Example 2, the solute content rate of the first solution is lower than the solute content rate of the nonaqueous electrolyte solution 140 (43.0 wt %). Also, in Example 2, the solute content rate of the second solution is set to 44.7 wt %. Hence, the solute content rate of the second solution is higher than the solute content rate of the nonaqueous electrolyte solution 140 (43.0 wt %). Mixing together the first solution and the second solution of Example 2 gives 125 g of the nonaqueous electrolyte solution 140.

### Comparative Example

In the comparative example, the nonaqueous electrolyte solution 140 was not divided into a first solution and a second solution. Instead, 125 g of the nonaqueous electrolyte solution 140 was injected into a battery case 110 in a single injection step (see Table 1). The operation of reducing the pressure within the battery case 110 then increasing the pressure was subsequently carried out a plurality of times (specifically, five times) in the same way as in step S4 of the embodiment. The pressure within the battery case 110 was then held in an atmospheric pressure state, thereby bringing impregnation of the nonaqueous electrolyte solution 140 to completion.

### Comparison of Impregnation Completion Times

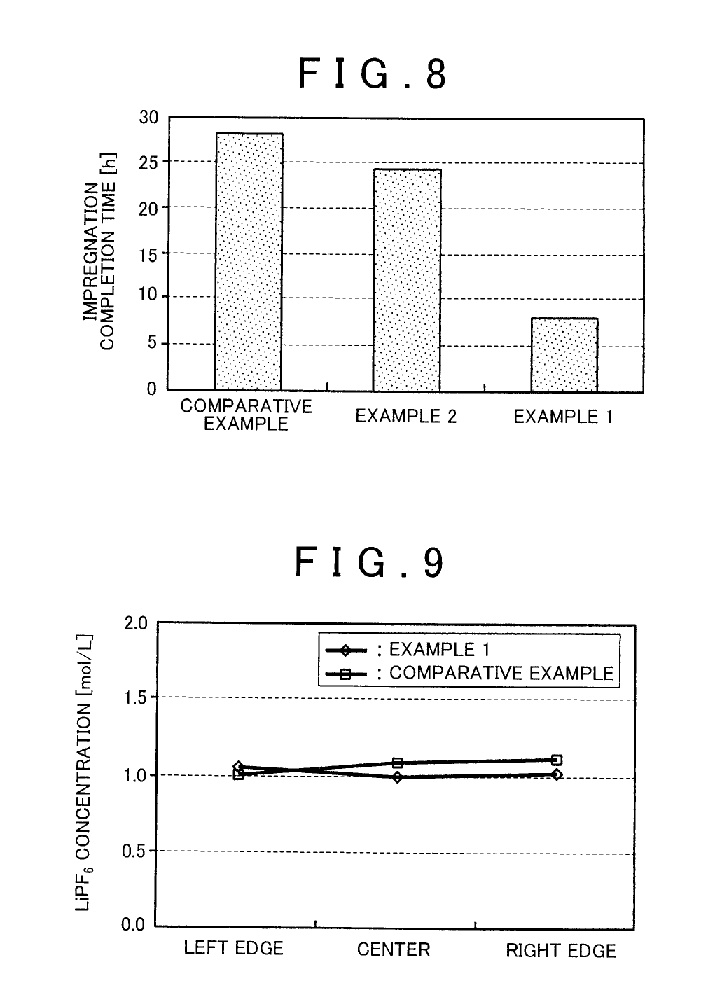

The nonaqueous electrolyte solution impregnation completion times were investigated for Examples 1 and 2 and the comparative example. The results are shown in FIG. 8.

In Comparative Example 1, the length of time from the end of injection of 125 g of the nonaqueous electrolyte solution 140 into the battery case 110 until impregnation of the nonaqueous electrolyte solution 140 into the electrode assembly 150 is complete was investigated. Specifically, a plurality of batteries were assembled and prepared for testing, and the nonaqueous electrolyte solution 140 was injected into each of the batteries. The above-described pressure reducing and increasing operation was subsequently carried out on each battery, following which, each time a fixed interval elapsed, one battery at a time was sampled and checked to determine whether impregnation of the nonaqueous electrolyte solution 140 into the electrode assembly 150 was complete.

Determinations as to whether impregnation was complete were made by carrying out initial charging of the sampled battery, then disassembling and analyzing the battery to check whether lithium had deposited on the surface of the negative electrode or the separator. When lithium was detected, it could be concluded that impregnation of the nonaqueous electrolyte solution 140 into the electrode assembly 150 was still incomplete. On the other hand, when lithium was not detected, it could be concluded that impregnation of the nonaqueous electrolyte solution 140 into the electrode assembly 150 was complete. For batteries in which lithium was not detected in this way, the elapsed time from the end of injection of the nonaqueous electrolyte solution 140 into the battery case 110 until the battery is sampled (until initial charging begins) was treated as the impregnation completion time.

As a result, in the comparative example, the impregnation completion time was 28 hours (see FIG. 8). That is, it took 28 hours from injection of the nonaqueous electrolyte solution 140 into the battery case 110 until impregnation of the nonaqueous electrolyte solution 140 into the electrode assembly 150 was complete.

The comparative example batteries in which lithium was not detected were checked to determine whether the nonaqueous electrolyte solution 140 had uniformly impregnated into the electrolyte assembly 150. If the nonaqueous electrolyte solution 140 has not uniformly impregnated into the battery assembly 150, the battery reactions will be non-uniform. Therefore, a method which is incapable of uniformly impregnating the nonaqueous electrolyte solution 140 into the electrode assembly 150 may be regarded as unsuitable. Therefore, the batteries are examined to determine whether the nonaqueous electrolyte solution 140 has uniformly impregnated into the electrode assembly 150.

Specifically, the electrode assembly 150 was disassembled (the coil was unwound), and the concentration of LiPF₆ was measured at three places on the surface of the negative electrode composite material layer coated region 156c. The three places of measurement were as follows: the center of the negative electrode composite material layer coated region 156c in the width direction (left-right direction in FIG. 4), and sites (a left edge site and a right edge site) located 10 mm toward the center from both edges (left edge and right edge in FIG. 4) in the width direction of the negative electrode composite material layer coated region 156c.

As a result of investigation, the LiPF₆ concentrations at each of these places were values close to 1.1 mol/L, and were thus substantially the same value as the LiPF₆ concentration (1.1 mol/L) of the nonaqueous electrolyte solution 140 (see FIG. 9). It can be concluded from these results that, in the comparative example batteries in which lithium was not detected, it was possible to uniformly impregnate the nonaqueous electrolyte solution 140 into the electrode assembly 150.

In Examples 1 and 2, in step S3 (first injection step), the length of time from the end of injection of the first solution into the battery case 110 until impregnation of the nonaqueous electrolyte solution 140 (the first solution plus the second solution) into the electrode assembly 150 is complete was investigated. Specifically, a plurality of batteries were assembled and prepared for testing, and steps S3 to S5 treatments were carried out on each of these batteries. Then, as described above, in step S6, the pressure reducing and pressure increasing operation was carried out on each battery, following which, each time a fixed interval elapsed, one battery at a time was sampled and checked to determine whether impregnation of the nonaqueous electrolyte solution 140 (the first solution plus the second solution) into the electrode assembly 150 was complete.

Determinations as to whether impregnation was complete were made, as in the comparative example, based on the presence or absence of lithium deposition. For batteries in which lithium was not detected in this way, the elapsed time from the end of injection of the first solution into the battery case 110 until the battery is sampled (until initial charging begins) was treated as the impregnation completion time.

As a result, in Example 2, the impregnation completion time was 24 hours (see FIG. 8). That is, it took 24 hours from injection of the first solution into the battery case 110 until impregnation of the nonaqueous electrolyte solution 140 (the first solution plus the second solution) into the electrode assembly 150 was complete. Hence, in Example 2, it was possible to reduce the impregnation time by 4 hours relative to the comparative example. It can be concluded from these results that it is possible to impregnate a nonaqueous electrolyte solution into an electrode assembly in a short period of time by the method of Example 2.

The reason why it was possible to shorten the impregnation completion time is that, in Example 2, the operation of injecting the nonaqueous electrolyte solution into the battery case was divided into two steps: a first injection step and a second injection step. A further reason is that, in the first injection step, a first solution having a lower solute content rate than the nonaqueous electrolyte solution was injected and, in the second injection step, a second solution formed of the ingredients of the nonaqueous electrolyte solution excluding ingredients of the first solution (which second solution had a higher solute content rate than the nonaqueous electrolyte solution) was injected.

The first solution having a lower solute content rate than the nonaqueous electrolyte solution has a faster rate of impregnation into the electrode assembly than the nonaqueous electrolyte solution. That is, the rate of impregnation by the first solution into the electrode assembly is more rapid than the rate of impregnation by the nonaqueous electrolyte solution. Moreover, when the second solution is injected in the second injection step, because the electrode assembly has already been wetted by the first solution (solvent), even the second solution having a high solute content rate is capable of being impregnated rapidly (in a short time) into the electrode assembly. As a result, the nonaqueous electrolyte solution formed of the first solution and the second solution can be impregnated into the electrode assembly in a short period of time.

In Example 1, the impregnation completion time was 8 hours (see FIG. 8). That is, it took only 8 hours from injection of the first solution into the battery case 110 until impregnation of the nonaqueous electrolyte solution 140 (the first solution plus the second solution) into the electrode assembly 150 was complete. Hence, in Example 1, it was possible to reduce the impregnation time by 20 hours relative to the comparative example (28 hours), and it was possible to reduce the impregnation time by 16 hours relative to Example 2 (24 hours). It can be concluded from these results that it is possible to impregnate a nonaqueous electrolyte solution into an electrode assembly in a very short period of time by the method of Example 1.

The reason why it was possible to shorten the impregnation completion time even further is that, in Example 1, part of the solvent included in the nonaqueous electrolyte solution is used as the first solution. That is, in the first injection step, part of the solvent included in the nonaqueous electrolyte solution (specifically, part of the DMC and part of the EMC) is injected into the battery case, following which, in the first impregnation step, this solvent is impregnated into the electrode assembly. The rate of impregnation of the solvent into the electrode assembly is very rapid compared with the rate of impregnation of the nonaqueous electrolyte solution (that is, the rate of impregnation of a solute-containing liquid). Moreover, because the electrode assembly has been wetted by the solvent (specifically, by DMC and EMC) prior to injection of the second solution, the rate of impregnation by the second solution having a high solute content rate can be speeded up. As a result, the nonaqueous electrolyte solution formed of the first solution and the second solution can be impregnated into the electrode assembly in a very short period of time.

The batteries of Examples 1 and 2 in which lithium was not detected were investigated in the same way as the batteries of the comparative example to determine whether the nonaqueous electrolyte solution 140 was uniformly impregnated into the electrode assembly 150. The results of the investigation indicated that, as shown in FIG. 9, the batteries of Example 1 in which lithium was not detected had LiPF₆ concentrations close to 1.1 mol/L at all places, which values substantially the same as the LiPF₆ concentration of the nonaqueous electrolyte solution 140 (1.1 mol/L). It can be concluded from these results that, in the batteries of Example 1 in which lithium was not detected, it was possible to uniformly impregnate the nonaqueous electrolyte solution 140 into the electrode assembly 150. Although the results for Example 2 are not shown in FIG. 9, the results were similar to those in Example 1.

It can be concluded from the above that the manufacturing methods of Examples 1 and 2 are suitable methods that enable a nonaqueous electrolyte solution to be uniformly impregnated into the electrode assembly, and moreover that these are excellent methods which enable the nonaqueous electrolyte solution (the first solution plus the second solution) to be impregnated into the electrode assembly in a short period of time.

The invention has been described above with respect to certain embodiments thereof, although the invention is not limited to the above embodiments and may be suitably modified and applied in other ways.

For example, in Example 1, a portion of the solvent included in the nonaqueous electrolyte solution 140 was used as the first solution. Specifically, part of the DMC and part of the EMC were selected as “part of the solvent included in the nonaqueous electrolyte solution” and used as the first solution. However, DMC alone may be selected as “part of the solvent included in the nonaqueous electrolyte solution” and DMC alone may be used as the first solution. Alternatively, EMC alone may be selected as “part of the solvent included in the nonaqueous electrolyte solution” and EMC alone may be used as the first solution. Yet another possibility is to carry out the injection step and the impregnation step three or more times each.

What is claimed is:

1. A method of manufacturing a nonaqueous electrolyte secondary battery including an electrode assembly that includes a positive electrode, a negative electrode and a separator, a battery case that houses the electrode assembly, and a nonaqueous electrolyte solution impregnated into the electrode assembly, comprising:
preparing the nonaqueous electrolyte solution in a divided form as a first solution having a lower solute content rate than the nonaqueous electrolyte solution and a second solution formed of ingredients of the nonaqueous electrolyte solution excluding ingredients of the first solution, and injecting the first solution into the battery case housing the electrode assembly;
impregnating the first solution into the electrode assembly;
injecting the second solution into the battery case; and
impregnating the second solution into the electrode assembly.

2. The manufacturing method according to claim 1, wherein the first solution is consisting of part of a solvent included in the nonaqueous electrolyte solution.

3. The manufacturing method according to claim 1, wherein, when the first solution is impregnated into the electrode assembly and when the second solution is impregnated into the electrode assembly, an operation of reducing pressure within the battery case then increasing the pressure is carried out a plurality of times.

4. A method of manufacturing a nonaqueous electrolyte secondary battery, comprising:
injecting a first nonaqueous electrolyte solution into a battery case housing an electrode assembly;
impregnating the first nonaqueous electrolyte solution into the electrode assembly;
injecting thereafter a second nonaqueous electrolyte solution having a higher solute concentration than the first nonaqueous electrolyte solution into the battery case; and
impregnating the second nonaqueous electrolyte solution into the electrode assembly.
